(19) United States
(12) Patent Application Publication
(10) Pub. No.: US 2010/0025109 A1
(43) Pub. Date: Feb. 4, 2010

(54) Apparatus and Method for Generating Formation Textural Feature Images

(75) Inventor: Padmakar Deo, The Woodlands, TX (US)

Correspondence Address: MADAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/510,906

(22) Filed: Jul. 28, 2009

Related U.S. Application Data
(60) Provisional application No. 61/084,809, filed on Jul. 30, 2008.

(51) Int. Cl. E21B 47/00; E21B 44/00; E21B 7/00; G06T 1/00

(52) U.S. Cl. 175/24; 175/40; 382/100

(57) ABSTRACT

Apparatus and methods for providing an image of a formation textural feature are disclosed, which in one aspect may include defining a plurality of sectors for a wellbore, obtaining wellbore image data corresponding to each sector over a wellbore depth, obtaining a gray level co-occurrence matrix from the wellbore image data for a selected textural feature of the formation, and generating from the gray scale co-occurrence matrix an image of the selected textural feature over the wellbore depth.

### CROSS-REFERENCE TO PRIOR APPLICATION

This application claims priority from the U.S. Provisional Patent Application having the Ser. No. 61/084,809 filed Jul. 30, 2008.

### BACKGROUND OF THE DISCLOSURE

1. Field of the Disclosure

This disclosure relates generally to an apparatus and method for providing images of formation features.

2. Description of the Related Art

Wellbores (or boreholes) are drilled in the earth's subsurface formations for the production of hydrocarbons (oil and gas), utilizing a rig (land or offshore) and a drill string. The drill string includes a drilling assembly (also referred to as a “bottomhole assembly” or “BHA”). The drilling assembly typically carries a variety of sensors that provide directional information, as well as a force application device that can be used to drill the wellbore along a desired wellbore path. The BHA also carries a variety of downhole tools (or sensors), referred to as the logging-while-drilling (“LWD”) or measurement-while drilling (“MWD”) tools, for estimating various parameters of the formation surrounding the wellbore. It is often useful to obtain an image of the inside of the wellbore to evaluate the formation and to enhance the effectiveness of the drilling operation. Electrical logging tools and acoustic tools are often used to obtain such wellbore images. These logs provide two dimensional images of the wellbore wall as a function of the wellbore depth. Wellbore features such as fractures, gouges, uneven size, etc. may be observed from such images. Such images, however, do not provide information about the various textural features of the formation surrounding the wellbore as a function of the wellbore depth. The textural features may include homogeneity, contrast and randomness. The information about the formation textural features can assist the driller in more precisely positioning the wellbore along a production zone or controlling a drilling parameter, such as rate of penetration, rate of drill bit rotation, etc. Therefore, there is a need for improved apparatus and methods that provide information about formation textural parameters.

### SUMMARY OF THE DISCLOSURE

In one aspect a method of providing information about formation textural feature during drilling of a wellbore is disclosed. The method in one aspect may include the features of obtaining wellbore image data for a plurality of azimuthal wellbore sectors corresponding to a plurality of depth points, generating co-occurrence values from the wellbore image data for the azimuthal wellbore sectors corresponding to the plurality of depth points, and generating an image of a textural feature using the co-occurrence values.

In another aspect, an apparatus for providing an image of a textural feature of a formation surrounding a wellbore is provided, which apparatus in one embodiment may include a sensor configured to provide signals relating to an image of the formation, a processor configured to: process the sensor signals to provide wellbore image data for plurality of azimuthal wellbore sectors over a selected wellbore depth; generate co-occurrence values from the wellbore image data corresponding to the wellbore sectors over the selected wellbore depth; and generate an image of a textural feature using the co-occurrence values.

Examples of the more important features of the methods and apparatus for generating formation feature images have been summarized rather broadly in order that the detailed description thereof that follows may be better understood and in order that the contributions they represent to the art may be appreciated. There are, of course, additional features of the disclosure that will be described hereinafter and which will form the subject of claims made.

### BRIEF DESCRIPTION OF THE DRAWINGS

For detailed understanding of the apparatus of and methods for generating and using formation feature images, reference should be made to the following detailed description, taken in conjunction with the accompanying drawing in which like elements are generally designated by like numerals and wherein:

FIG. 1 is a schematic illustration of an exemplary drilling system that includes a drilling assembly that carries a formation feature image device made according to one embodiment of the disclosure;

FIG. 2 shows a producing formation (or production zone) with a dip and a pair of exemplary wellbores formed therein according to one aspect of the disclosure;

FIG. 3 is a functional block diagram depicting certain elements of the image device according to on aspect of the disclosure;

FIG. 4 is an exemplary data matrix or log of a formation parameter provided by a downhole tool during drilling of a wellbore for use by the formation feature image device of the present disclosure;

FIG. 5 shows a hypothetical integer data matrix that may be derived from a formation parameter data matrix, such as shown in FIG. 4;

FIG. 6 shows a gray level co-occurrence matrix derived for a single window of the integer matrix shown in FIG. 5; and

FIG. 7 is an example of an image of textural features generated from a gray level co-occurrence data according to one method of the disclosure.

### DETAILED DESCRIPTION OF THE DISCLOSURE

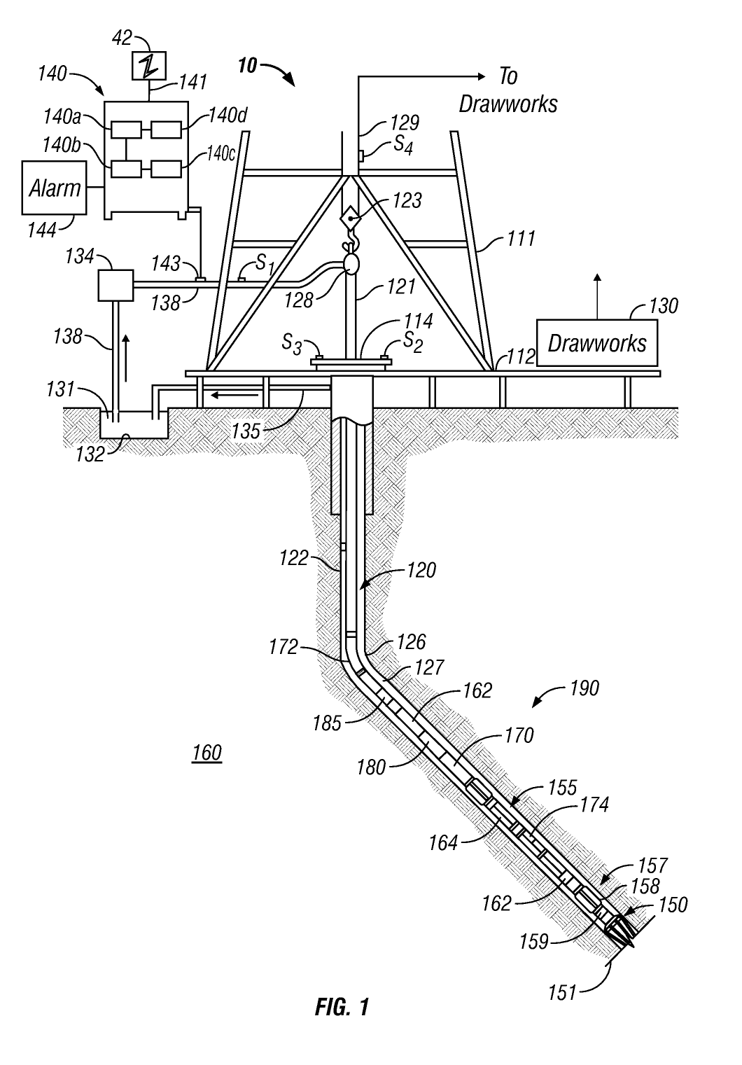

FIG. 1 shows a schematic diagram of a drilling system 100 for drilling a wellbore 126 in an earth formation 160 and for estimating properties or characteristics of interest of the formation surrounding the wellbore 126 during the drilling of the wellbore 126. The drilling system 100 is shown to include a drill string 120 that comprises a drilling assembly (or BHA) 190 attached to a bottom end of a drilling tubular (drill pipe) 122. The drilling system 100 is further shown to include a conventional derrick 111 erected on a floor 112 that supports a rotary table 114 that is rotated by a prime mover, such as an electric motor (not shown), to rotate the drilling tubular 122 at a desired rotational speed. The drilling tubular 122 is typically made up of jointed metallic pipe sections and extends downward from the rotary table 114 into the wellbore 126. A drill bit 150 attached to the end of the BHA 190 disintegrates the geological formations when it is rotated to drill the wellbore 126. The drill string 120 is coupled to a drawworks 130 via a Kelly joint 121, swivel 128 and line 129 through a pulley 123. During the drilling of the wellbore 126 draw works 130 controls the weight on bit which affects the rate of penetration.

During the drilling operations, a suitable drilling fluid or mud 131 from a source or mud pit 132 is circulated under pressure through the drill string 120 by a mud pump 134. The drilling fluid 131 passes from the mud pump 134 into the drilling tubular 122 via a desurger 136 and a fluid line 118. The drilling fluid 131 is discharged at the wellbore bottom 151 through an opening in the drill bit 150. The drilling fluid 131 circulates uphole through the annular space 127 between the drill string 120 and the wellbore 126 and returns to the mud pit 132 via return line 135. A sensor S1 in the line 138 provides information about the fluid flow rate. A surface torque sensor S₂ and a sensor S₃ associated with the drill string 120 respectively provide information about the torque and the rotational speed of the drill string. Additionally, one or more sensors (collectively referred to as S₄) associated with line 129 are typically used to provide information about the hook load of the drill string 120 and other desired drilling parameters relating to drilling of the wellbore 126.

In some applications the drill bit 150 is rotated by rotating only the drilling tubular 122. However, in other applications a drilling motor (also referred to as the “mud motor”) 155 disposed in the drilling assembly 190 is used to rotate the drill bit 150 and/or to superimpose or supplement the rotational speed of the drilling tubular 122.

The system 100 may further include a surface control unit 140 configured to provide information relating to the drilling operations and for controlling certain desired drilling operations. In one aspect the surface control unit 140 may be a computer-based system that includes one or more processors (such as microprocessors) 140a, one or more data storage devices (such as solid state-memory, hard drives, tape drives, etc.) 140b, display units and other interface circuitry 140c. Computer programs and models 140d for use by the processors 140a in the control unit 140 are stored in a suitable data storage device 140b, including, but not limited to: a solid-state memory, hard disc and tape. The surface control unit 140 also may interact with one or more remote control units 142 via any suitable data communication link 141, such as the Ethernet and the Internet. In one aspect signals from the downhole sensors and devices 143 (described later) are received by the control unit 149 via a communication link, such as fluid, electrical conductors, fiber optic links, wireless links, etc. The surface control unit 140 processes the received data and signals according to programs and models 140d provided to the control unit and provides information about drilling parameters such as WOB, RPM, fluid flow rate, hook load, etc. and formation parameters such as resistivity, acoustic properties, porosity, permeability, etc. The surface control unit 140 records such information. This information, alone or along with information from other sources, may be utilized by the control unit 140 and/or a drilling operator at the surface to control one or more aspects of the drilling system 100, including drilling the wellbore along a desired profile (also referred to as “geosteering”).

Still referring to FIG. 1, BHA 190, in one aspect, may include a force application device 157 that may contain a plurality of independently-controlled force application members 158, each of which may configured to apply a desired amount of force on the wellbore wall to alter the drilling direction and/or to maintain the drilling of the wellbore 126 along a desired direction. A sensor 159 associated with each respective force application member 158 provides signals relating to the force applied by its associated member. The drilling assembly 190 also may include a variety of sensors, collectively designated herein by numeral 162, located at selected locations in the drilling assembly 190, that provide information about the various drilling assembly operating parameters, including, but not limited to: bending moment, stress, vibration, stick-slip, tilt, inclination and azimuth. Accelerometers, magnetometers and gyroscopic devices, collectively designated by numeral 174, may be utilized for determining inclination, azimuth and tool face position of the drilling assembly operating parameters, using programs and models provided to the downhole control unit 170. In another aspect, the sensor signals may be partially processed downhole by the downhole control unit 170 and then sent to the surface controller 140 for further processing.

Still referring to FIG. 1, the drilling assembly 190 may further include any desired MWD (or LWD) tools, collectively referred to by numeral 164, for estimating various properties of the formation 160. Such tools may include resistivity tools, acoustic tools, nuclear magnetic resonance (NMR) tools, gamma ray tools, nuclear logging tools, formation testing tools and other desired tools. Each such tool may process signals and data according to programmed instructions and provide information about certain properties of the formation.

Still referring to FIG. 1, the drilling assembly 190 further includes a telemetry unit 172 that establishes two-way data communication between the devices in the drilling assembly 190 and a surface device, such as the control unit 140. Any suitable telemetry system may be used for the purpose of this disclosure, including, but not limited to: mud pulse telemetry, acoustic telemetry, electromagnetic telemetry and wired-pipe telemetry. In one aspect, the wired-pipe telemetry may include drill pipes made of jointed tubulars in which electrical conductors or fiber optic cables are run along individual drill pipe sections and wherein communication along pipe sections may be established by any suitable method, including, but not limited to: mechanical couplings, fiber optic couplings, electromagnetic signals, acoustic signals, radio frequency signals, or another wireless communication method. In another aspect, the wired-pipe telemetry may include coiled tubing in which electrical or fiber optic fibers are run along the length of coiled tubing. The drilling systems, apparatus and methods described herein are equally applicable to offshore drilling systems.

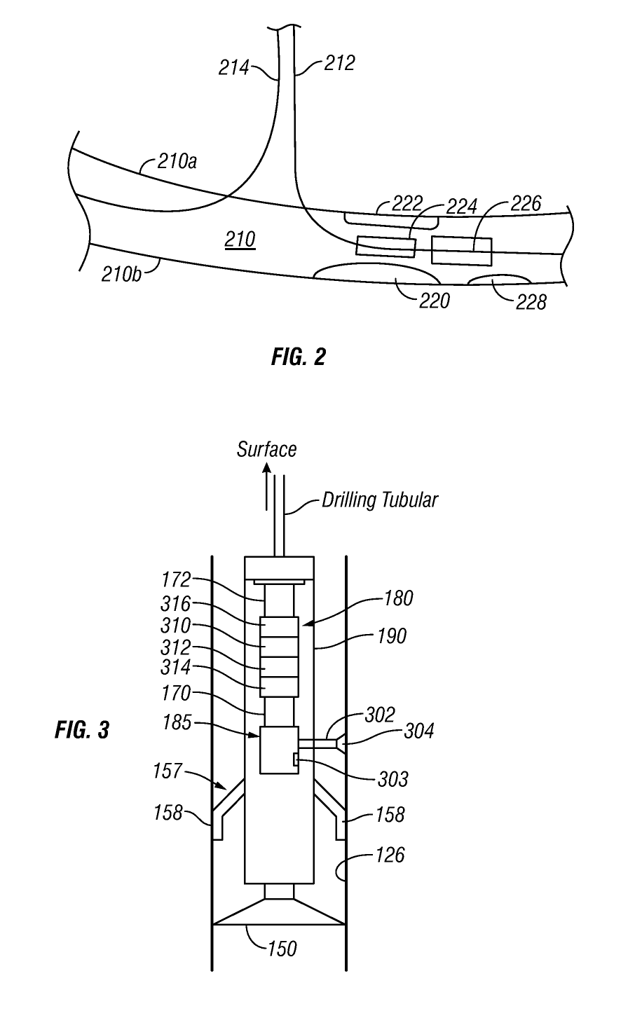

Still referring to FIG. 1, the BHA 190 in one aspect may include an image tool 180 for providing an image of the wellbore. The image tool 180 may be any suitable wellbore image tool, including, but not limited to: an electrical logging tool, an acoustic logging tool, a density tool and a caliper. The image tool 180 provides data relating to the wellbore image from which visual images relative to the wellbore depth (image logs) may be generated. In one aspect, the wellbore image data may be in a digital form, such as a numerical value of a selected parameter. The parameter may be current, voltage, acoustic signals amplitude, and density. The term “depth” herein means the location in the wellbore relative to a reference point, such as the surface. The BHA 190 further may include a control unit 185 that is configured to process the image data provided by the image tool 180 and to generate data relating to the images of one or more textural features of the formation through which the wellbore is being drilled. The formation textural features may include features not affected by the bed boundary conditions such as: contrast, homogeneity and randomness of the sedimentary rock as described in more detail in reference to FIGS. 2-7.

FIG. 2 shows exemplary wells 212 and 214 in a formation 210. The formation 210 is shown to have a dip and be bounded by bed boundaries 210a and 210b. Wellbore 212 is shown drilled along a down-dip of the formation, while wellbore 214 is shown drilled along an up-dip of the formation 210. The textural features of a sedimentary formation such as formation 210 often vary. For example, formation 210 may contain coarse sand 220 along the bottom of the formation, fine sand 222 along an upper zone, contrasting sands along a section 224, homogeneous sand in a zone 226 and fractures 228. The various textural features shown in FIG. 2 are arbitrarily designated for the purpose of ease of explanation of the apparatus and methods of this disclosure. Aspects of the apparatus and methods to generate images of such textural features during drilling of wellbores are described in more detail in reference to FIGS. 3-6.

FIG. 3 is a functional block diagram showing certain elements of the image tool 185 and formation feature imaging device 180, according to one aspect of the disclosure. FIG. 3 also shows the drill bit 150 coupled to the BHA 190 and the steering device 157 containing the plurality of force application members 158 for changing the drilling direction. In one embodiment, the image tool 185 may be an electrical logging tool which includes one or more electrodes 302 formed on a pad 304. In one aspect, the pad 304 may extend outward from the BHA 190 and contact the wellbore wall during drilling of the wellbore 126. The pad 304 and electrodes 302 rotate as the BHA 190 rotates. In one aspect, current may be induced into the formation by the electrodes 302 that are held at a common potential. The current induced by a particular electrode will depend upon the resistivity of the formation area covered by the electrode. In one aspect, the downhole controller 170 may process the measured current data and provide data relating to the image of the wellbore 126. Alternatively, the measured current data may be processed by the surface controller 140 or partially processed by the downhole controller 180 and partially by the surface controller. The image tool 185 may be configured to provide relatively high resolution data so that relatively high resolution images of the textural features of the formation 210 may be generated utilizing the apparatus and methods disclosed herein. For example, each revolution of the tool 185 may be divided into a number of sectors that will provide the desired resolution for the textural feature images. The number of sectors in tools often varies from 16 sectors to 120 sectors. Any other number of sectors also may be utilized for generating the textural feature images using the methods described herein. Any other technique may also be used to provide high resolution data for the purposes of this disclosure. In another aspect, the image tool 185 may be an acoustic image logging tool, wherein an acoustic transducer induces acoustic signals into the wellbore wall and receives acoustic signals from the formation in response to the induced acoustic signals. The controller 170 and/or 140 processes the received acoustic signals and provides data relating to the image of the wellbore. In another aspect, a density tool or a caliper may be used as the image tool 185 to provide data relating to the image of the wellbore 126.

Still referring to FIG. 3, a control unit 180 carried by the BHA 190 may be utilized to process the image data from the image tool 185 to generate the formation textural feature image data. The control unit 180 may include a processor 310, a data storage device 312, such as solid-state memory, hard disc, tape, etc., for storing data received from the image tool 185 and programmed instructions and models 314 for use by the processor 310. The control unit 180 also may include electronic circuitry 316 necessary for performing other desired operations and functions.

In operation, the image tool 185 generates digital data in the form of discrete numerical values. Each such numerical value corresponds to information relating to a relatively small distance along the wellbore, which, for convenience, is referred to herein a depth point. For example, in the case of an image tool that divides the measurements into 16 sectors along the wellbore wall, 16 numerical values, one corresponding to each sector, will be generated. The image data may be accumulated and averaged over revolutions of the BHA 190 that correspond to each depth point. The number of the revolutions is based on the rotational speed of the BHA 190, rate of penetration of the drill bit 150 and the distance selected for each point.

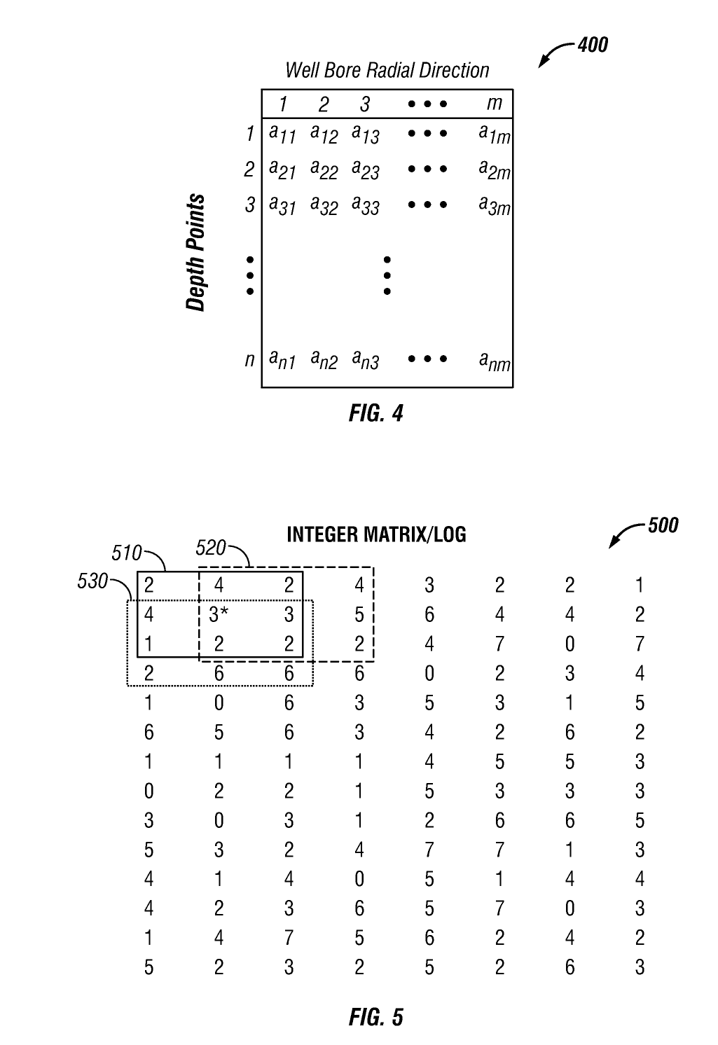

FIG. 4 shows an image data matrix 400 containing hypothetical numerical values aᵢⱼ generated by the image tool 185, wherein the first subscript “i” represents a depth point and the second subscript “j” represents a sector along the wellbore wall. The data in matrix 400 corresponds to “m” wellbore sectors and “n” depth points. The data in matrix 400 is also referred to herein as the “initial image data.” The horizontal direction (aᵢⱼ to aᵢₘ) represents the wellbore azimuthal direction and the vertical direction (aᵢⱼ to aᵢₘ) represents the wellbore depth points.

In one aspect, the processor 310 is configured to transform the numerical values in matrix 400 into a matrix of integers, there being a one-to-one correspondence between the numerical values of FIG. 4 and the integers, as shown in FIG. 5.

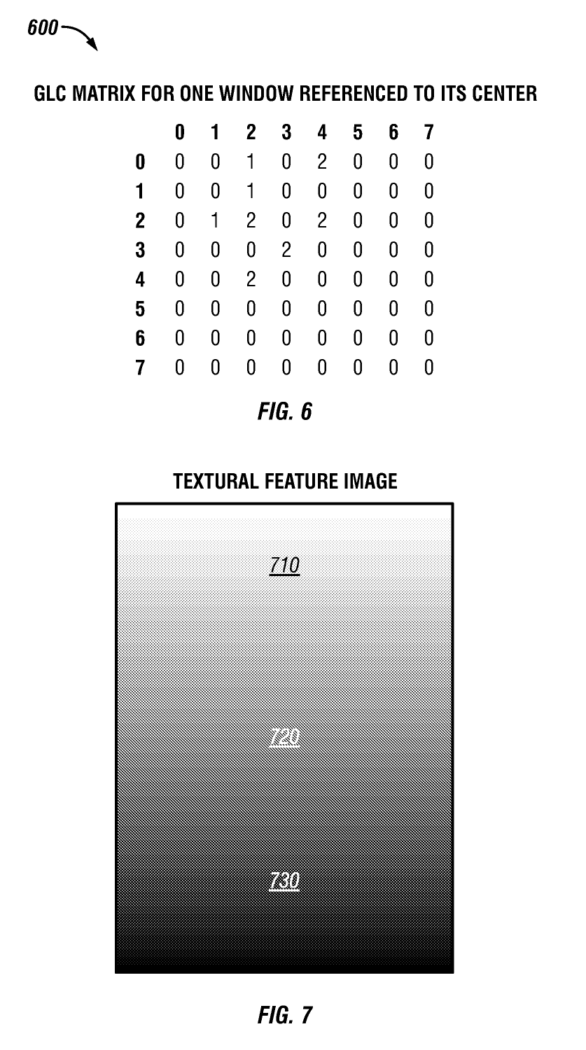

FIG. 5 shows a hypothetical integer matrix that is derived by converting the data in the image data matrix 400 to integers. Converting the image data into integers affords an easier comparison for computing a gray level co-occurrence matrix (“GLCM”) as described later in reference to FIG. 6. Instead of converting the image data into integers, the image matrix values may be converted into fractional data or the values may be utilized directly to obtain the GLCM. The exemplary integer matrix 500 is created from the image data matrix 400. For the purpose of explaining the creation of the integer matrix 500, it is assumed that all aᵢⱼ values in the matrix 500 are between numbers 2.0 and 3.0. The values in matrix 400 are then divided into a selected number of levels. In the example of integer matrix 500, the values in matrix 400 are divided into eight (8) levels and each value in matrix 400 is then assigned an integer value based on the level in which it resides. For convenience, the eight integers assigned to the eight levels are represented by numbers zero (0) through seven (7). For example, an image data value residing between 2.0 and 2.125 is assigned a value 0 while the image data residing between 2.875 and 3.00 is assigned a value 7. Therefore, the integer matrix 500 shows the integers between 0 and 7. It is noted that any number of levels may be utilized for creating the integer matrix 500.

FIG. 6 shows a GLCM 600 corresponding to the integers lying in a single window or cell 510 of the integer matrix 500. In the particular example of FIG. 6, the window is chosen to be 3×3, i.e., three consecutive values from each row of three consecutive columns. A GLCM resolution is then defined, which determines the size of the GLCM for each window. For an n×n resolution, the GLCM for each window will be n×n in size, where n is the number of bit resolutions. If one uses 8 bits to resolve data, the GLCM would be 8×8=64. In one aspect, the GLCM 600 for the window 510 is constructed in reference to the center (number 3) of the window 501. The processor 310 computes the number of times a particular number occurs next to each of the possible integers in the integer matrix 500. A particular number occurs next to another number when the particular number is either to the left or right of the other number. In the particular example of matrix 500, the possible numbers in the matrix 500 are 0-7. As an example, in the window 510, the number 2 occurs twice next to the number 4 (see first row, once on the right of the number 4 and once on the left of the number 4); two times next to number 2 (see third row, once on the right and once on the left); and one time next to number 1 (see third row, only going to the left). Therefore, in the matrix 600, the number corresponding to integers 2 and 4 in the first window of matrix 500 is 2, the number corresponding to integers 2 and 2 is 2 and the number corresponding to integers 2 and 1 is 1. All other numbers along the number 2 are zeros. The co-occurrence numbers are then calculated for each of the remaining integers 0, 1, and 3-7 of matrix 500 in the same manner. The GLCM is then computed by moving the window 510 one column to the right, as shown by window 520. Once a GLCM for each of the 8 windows in the horizontal direction has been computed, the window 510 is moved downward, as shown by window 530. When the window is at the far edge, the next window may be obtained by wrapping such a window around one column in the matrix. In this manner, the processor may generate one GLCM for each possible window. The processor 310 then computes a numerical value for each GLCM corresponding to each desired textural features using any suitable formulas. Such a numerical value is calculated for the center value of each window. The processor 310 then may assign colors to the values of the textural feature computed from the GLCM 600 and generate an image of each desired textural feature utilizing such values.

FIG. 7 shows an exemplary image of a textural feature which may be homogeneity, contrast or randomness. Homogeneity may be defined as a measure of overall smoothness of an image. Contrast may be defined as a measure of the image contrast or amount of local variation in an image. Randomness may be defined as the unevenness of the image. These formation textural features may be derived from the covariance matrix using any suitable formula or method.

Still referring to FIG. 7, in one aspect the processor 310 may assign a light color 710 to low values of the textural feature values and a dark color 730 to the high values of the textural feature or vice versa. In another aspect, the processor 310 may assign different colors or varying colors to distinguish the changes in the textural feature. For example, in FIG. 7, the color is shown changing from a light color 710 to medium dark 720 to dark 730, signifying that the textural feature is changing and the extent of change. The extent of change may be estimated from the color changes or computed from the calculated values of the textural features as the wellbore is being drilled. Therefore, when the image 700 represents formation homogeneity and the lightest color represents a highly homogeneous formation and the darkest color represents a highly inhomogeneous formation, the image of FIG. 7 will indicate that the formation is changing from a highly homogeneous formation to a highly inhomogeneous formation. In one aspect, the color scale may be assigned a numerical range, such as 1 for the lightest color and 100 for the darkest color to provide a numerical homogeneity scale for ease of interpretation. Similar methods may be used for other textural features, such as contrast and randomness. Although the processing of the image data shown in FIG. 4 is described in reference to the processor 310 in the BHA 190, such processing may be carried out in a number of alternative ways. For example, the image data of FIG. 4 may be sent to the surface during drilling and the processing may be done by the controller 140. In another aspect, the processing may be carried out by the downhole controller 170 or by combination of the downhole and surface processor.

In another aspect, the textural feature data and/or images may be utilized to take one or more actions. Such actions may be taken automatically or manually by a drilling operator to improve the drilling efficiency (for example improved rate of penetration) and/or to extend the life of the BHA. In another aspect, the feature image information may be utilized to change the drilling direction using the steering device 157 so as to drill the wellbore along a more favorable section of the same sedimentary formation. For example, the drilling direction may be changed to drill the wellbore: from sand with more contrast to sand with less contrast; from coarse sand to smooth sand; or from less homogeneous sand to more homogeneous sand. The controller 140 at the surface and/or the downhole controller 170 may automatically cause the force application members 158 to change the drilling direction or the drilling operator may take such an action.

Thus, in one aspect, a method of providing an image of a formation textural feature may include: obtaining wellbore image data for a selected wellbore depth corresponding to a plurality of azimuthal wellbore sectors; computing a GLCM from the wellbore image data; and generating an image of a textural feature using the GLCM. In one aspect the method may comprise defining a plurality of sectors for the wellbore azimuthal and wherein the wellbore image data corresponds to each of the sectors. The method may further include converting the wellbore image data into integer data before computing the GLCM. The textural features may include, but are not limited to: homogeneity, contrast and randomness of the formation. Also, the wellbore image data may be obtained by using any suitable downhole tool, including, but not limited to: (i) an acoustic logging tool; (ii) an electric image logging tool; and (iii) a density logging tool.

In another aspect, the in-situ obtained formation textural feature images or data may be utilized to control the drilling direction (geosteering). In one aspect, the method may further include changing the drilling direction, based at least in part on the formation textural feature image data, so as to improve the drilling efficiency and/or extend the life of the BHA. In another aspect, the method may comprise: obtaining additional wellbore image data; creating an image of at least one formation feature using the additional wellbore image data; and comparing the initial feature image with the feature image created by using the additional wellbore image data. Each wellbore image may correspond to one of: (i) an up-dip section of a formation; (ii) a down-dip section of the formation; and (iii) different wellbores.

In another aspect, the apparatus for providing images of a formation textural feature may include: a downhole sensor configured to process the sensor signals to provide data relating to an image of the wellbore; and a processor configured to generate one or more images of one or more textural features of the formation using the data relating to the image of the wellbore. The apparatus may further include a data storage device and programs and models accessible to the processor. The apparatus may further include a steering device that is configured to change the drilling direction. In one aspect, the processor may be configured to cause the steering device to change the drilling direction in response to programmed instruction.

The foregoing description is directed to particular embodiments of the apparatus and methods for generating textural feature images for the purpose of illustration and explanation. It will be apparent, however, to one skilled in the art that many modifications and changes to the embodiments and methods set forth above are possible without departing from the scope the disclosure. It is intended that any claims made based on this disclosure be interpreted to embrace all such modifications and changes.

What is claimed is:

1. A method of providing an image of a textural feature of a formation, comprising:
obtaining wellbore image data for a plurality of azimuthal wellbore sectors corresponding to a plurality of depth points;
generating co-occurrence values from the wellbore image data for the azimuthal wellbore sectors corresponding to the plurality of depth points; and
generating an image of a textural feature using the co-occurrence values.

2. The method of claim 1 wherein obtaining the wellbore image data comprises obtaining such data by using an image tool.

3. The method of claim 1, wherein image data corresponding to each azimuthal wellbore sector is numerical data, the method further comprising converting the numerical data into an integer data before computing the co-occurrence values.

4. The method of claim 1, wherein generating an image of a textural feature using the co-occurrence values comprises generating a gray level co-occurrence matrix.

5. The method of claim 1, wherein the textural feature is one of: (i) homogeneity; (ii) contrast; (iii) and randomness.

6. The method of claim 1, wherein obtaining the wellbore image data comprises obtaining data that is one of: (i) acoustic data; (ii) electrical data; and (iii) density data.

7. The method of claim 1 further comprising controlling a drilling operation during drilling of a wellbore based at least in part on the generated image of the textural feature.

8. The method of claim 7, wherein controlling a drilling operation includes changing one of a: drilling direction; rate of penetration of a drill bit into the formation; rotational speed of a drill bit; and weight-on-bit.

9. The method of claim 1, wherein the image of the textural feature corresponds to at least one of: (i) an up-dip section of a formation; (ii) a down-dip section of a formation; and (iii) a deviated wellbore.

10. An apparatus for providing an image of a textural feature of a formation surrounding a wellbore, comprising:
a sensor configured to provide signals relating to an image of the formation; a processor configured to:
process the sensor signals to provide wellbore image data for plurality of azimuthal wellbore sectors over a selected wellbore depth;
generate co-occurrence values from the wellbore image data corresponding to the wellbore sectors over the selected wellbore depth; and
generate an image of a textural feature using the co-occurrence values.

11. The apparatus of claim 10, wherein the image data corresponding to each sector is a numerical data and the processor is further configured to convert the numerical data into an integer data before computing the co-occurrence values.

12. The apparatus of claim 10, wherein the processor is further configured to generate a gray level co-occurrence matrix before generating the image of a textural feature.

13. The apparatus of claim 10, wherein the textural feature is one of: (i) homogeneity; (ii) contrast; (iii) and randomness.

14. The apparatus of claim 10, wherein the sensor is one of: (i) an acoustic sensor; (ii) a resistivity sensor; and (iii) a density sensor.

15. The apparatus of claim 10, wherein the processor is further configured to control an operation of a drilling assembly during drilling of a wellbore using at least in part the generated image of the textural feature.

16. The method of claim 15, wherein the operation includes changing one of: drilling direction; rate of penetration of a drill bit into the formation; rotational speed of a drill bit; and weight-on-bit.

17. The apparatus of claim 10, wherein the image of the textural feature corresponds to at least one of: (i) an up-dip section of a formation; (ii) a down-dip section of a formation; and (iii) a deviated wellbore.

18. A computer-readable medium including a computer program embedded therein and accessible to a processor configured to execute instruction contained in the computer program, the instructions comprising:
instructions to process sensor signals to provide wellbore image data for a plurality of azimuthal wellbore sectors over a selected wellbore depth;
instructions to generate co-occurrence values from the wellbore image data corresponding to the wellbore sectors over the selected wellbore depth; and
instructions to generate an image of a textural feature using the co-occurrence values.

19. The computer-readable medium of claim 18, wherein the computer program embedded therein further includes instructions to:
generate a gray scale level co-occurrence matrix; and
generate the image of a textural feature using the co-occurrence.

20. The computer-readable medium of claim 19, wherein the computer program embedded therein further includes instructions to generate the image of a textural feature that is one of: (i) homogeneity; (ii) contrast; (iii) and randomness.
